(19) United States
(12) Patent Application Publication
(10) Pub. No.: US 2010/0012855 A1
(43) Pub. Date: Jan. 21, 2010

(54) Wafer Scanning

(75) Inventors: Guenadiy Lazarov, Landing, NJ (US); Laura Zheng, Rockaway, NJ (US); Aleksandr Pinskiy, Wanaque, NJ (US)

Correspondence Address: HARRINGTON & SMITH, PC, 4 RESEARCH DRIVE, SHELTON, CT, 06484-6212, US

(73) Assignee: RUDOLPH TECHNOLOGIES, INC, FLANDERS, NJ (US)

(21) Appl. No.: 11/921,354

(22) PCT Filed: Jun. 2, 2006
(86) PCT No.: PCT/US2006/021531

§ 371 Date: Oct. 5, 2009

Related U.S. Application Data
(60) Provisional application No. 60/687,274, filed on Jun. 3, 2005.

(51) Int. Cl. G01N 21/00

(52) U.S. Cl. 250/491.1

(57) ABSTRACT

A semiconductor wafer measuring device including a wafer mover adapted to move a semiconductor wafer; a measurement head adapted to scan a surface of the semiconductor wafer as the semiconductor wafer is moved by the wafer mover; and a controller. The controller is adapted to control movement of the wafer mover to provide a first scanning segment of a first portion of the surface of the semiconductor wafer without rotating the semiconductor wafer during the first scanning segment, a second scanning segment of a second different portion of the surface of the semiconductor wafer without rotating the semiconductor wafer during the second scanning segment; and rotating the semiconductor wafer between the first and second scanning segments.

### BACKGROUND OF THE INVENTION

1. Field of the Invention

The invention relates to scanning a surface of a semiconductor wafer and, more particularly, to decreasing the footprint of a scanning device.

2. Brief Description of Prior Developments

U.S. Pat. No. 6,320,609 B1 discloses measurement and inspection systems. The system has a polar coordinate stage with a rotatable platform and a linear drive. A control system has an image rotator to rotate an image to compensate for rotation of the rotatable platform during scanning. U.S. Pat. No. 5,982,166 discloses a method for measuring a wafer. The measurement arm has a radial control as well as a rotational control. The wafer chuck is rotated while moving the measurement arm in a radial direction.

U.S. Patent Application Publication No.: 2004/0095575 A1 discloses an apparatus for inspecting a wafer having two image acquisition units. The second image acquisition unit can rotate to view the side edge of the wafer.

There is trend in the semiconductor industry to migrate from large stand-alone tools to more compact integrated metrology (i-MOD) units. The i-MOD approach will allow for combination of different technologies on one multi-head tool. The result is increased throughput, enhanced functionality, and reduced cost of ownership. The current metrology heads are incompatible with the i-MOD approach because of their size. A new design is required to meet the industry challenges for increased throughput and reduced tool size.

### SUMMARY OF THE INVENTION

In accordance with one aspect of the invention, a semiconductor wafer measuring device is provided including a wafer mover adapted to move a semiconductor wafer; a measurement head adapted to scan a surface of the semiconductor wafer as the semiconductor wafer is moved by the wafer mover; and a controller. The controller is adapted to control movement of the wafer mover to provide a first scanning segment of a first portion of the surface of the semiconductor wafer without rotating the semiconductor wafer during the first scanning segment, a second scanning segment of a second different portion of the surface of the semiconductor wafer without rotating the semiconductor wafer during the second scanning segment; and rotating the semiconductor wafer between the first and second scanning segments.

In accordance with another aspect of the invention, a semiconductor wafer measuring device is provided comprising a wafer mover adapted to move a semiconductor wafer; a movable measurement head adapted to scan a surface of the semiconductor wafer as the semiconductor wafer is moved by the wafer mover; and a controller. The controller is adapted to control movement of the wafer mover and the location of the movable measurement head to provide a first scanning segment of a first portion of the surface of the semiconductor wafer without rotating the semiconductor wafer during the first scanning segment and without moving the movable measurement head during the first scanning segment, a second scanning segment of a second different portion of the surface of the semiconductor wafer without rotating the semiconductor wafer during the second scanning segment and without moving the movable measurement head during the second scanning segment; and, after the first scanning segment and before the second scanning segment, moving the movable measurement head by translation movement only from a first position to a second position.

In accordance with one method of the invention, a semiconductor wafer measurement method is provided comprising moving a semiconductor wafer and scanning a first scanning segment of a first portion of a surface of the semiconductor wafer without rotating the semiconductor wafer during the first scanning segment; moving the semiconductor wafer and scanning a second scanning segment of a second different portion of the surface of the semiconductor wafer without rotating the semiconductor wafer during the second scanning segment; and rotating the semiconductor wafer between the first and second scanning segments.

In accordance with another method of the invention, a semiconductor wafer measurement method is provided comprising moving a semiconductor wafer and scanning a first scanning segment of a first portion of a surface of the semiconductor wafer without rotating the semiconductor wafer during the first scanning segment and without moving a movable measurement head during the first scanning segment; moving the semiconductor wafer and scanning a second scanning segment of a second different portion of the surface of the semiconductor wafer without rotating the semiconductor wafer during the second scanning segment and without moving the movable measurement head during the second scanning segment; and between the first and second scanning segments, moving the movable measurement head by translation movement only from a first position to a second position.

### BRIEF DESCRIPTION OF THE DRAWINGS

The foregoing aspects and other features of the invention are explained in the following description, taken in connection with the accompanying drawings, wherein:

FIG. 1 is a top view diagram illustrating one type of conventional metrology system;

FIG. 2 is a diagram illustrating components of a system incorporating features of the invention;

FIG. 3 is a top view diagram illustrating movement of a wafer in the system shown in FIG. 2;

FIG. 4 is a top view diagram similar to FIG. 3 illustrating another method and system of the invention;

FIG. 5 is a top view diagram similar to FIG. 3 illustrating another method and system of the invention; and

FIG. 6 is a diagram illustrating scan areas on the top surface of a wafer and corresponding scan segments used to scan the areas.

### DETAILED DESCRIPTION OF THE PREFERRED EMBODIMENTS

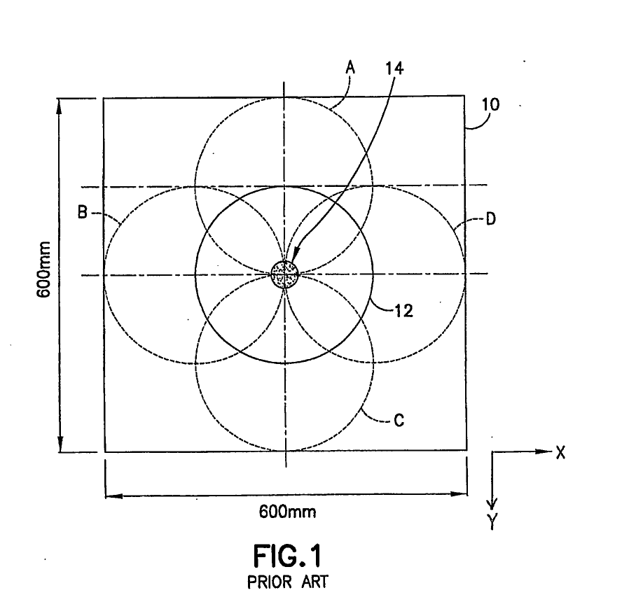

Referring to FIG. 1 there is shown a diagram illustrating one type of conventional metrology system. The system comprises a semiconductor wafer chamber having wafer space 10 of about 600 mm×600 mm in the X-Y directions. The system has a wafer support and movement system (not shown) for supporting and moving the semiconductor wafer 12, such as a 300 mm wafer for example, inside the wafer space 10 in X, Y and Z directions. The system also has a measurement head 14. For example, the measurement head can comprise a laser and a receiver. The measurement head 14 is located above the wafer 12 at a fixed position in the chamber 10, such as in the center of the chamber.

The wafer support and movement system is adapted to move the wafer 12, located below the measurement head 14, in X and Y directions±150 mm from the central position shown in FIG. 1 to the four maximum positions A, B, C, D shown in dotted lines. This allows the entire top surface of the wafer 12 to be scanned by the measurement head. The problem with this type of system, as noted above, is the size of the chamber because of the needed wafer space 10. There is a desire to reduce the size of the chamber, but still measure two-dimensional (2-D) structures on product wafers, such as line structures for example, where the orientation of the lines with respect to the incident laser beam is very important and cannot be arbitrary. Thus, an arbitrary wafer orientation cannot be used.

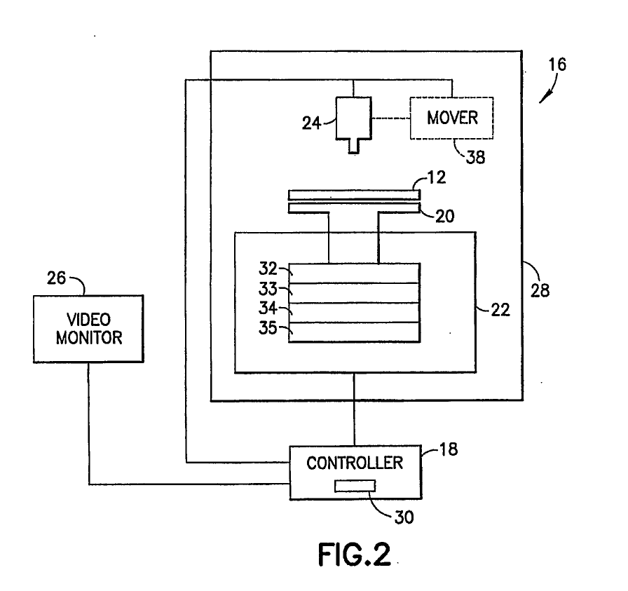

Referring to FIG. 2, there is shown a diagram of a metrology system 16 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

The invention proposes a solution which will decrease the wafer space for a 300 mm wafer to 600 mm×450 mm (FIGS. 2 and 3). The decreased required wafer space will allow for a smaller wafer chamber. The measurement signal is generated as a result of interaction between an incident laser beam and a sample (such as a wafer for example). Two-dimensional structures on product wafers can be measured, such as line structures for example. The orientation of the lines with respect to the incident laser beam is very important and cannot be arbitrary. This is the reason why an arbitrary wafer orientation, such as in U.S. Pat. No. 6,320,609 for example, cannot be used. The invention can comprise a design of a reduced size X-Y stage with an asymmetric location of the measurement head and an algorithm to access every point of a 300 mm wafer. The invention could also be used with wafers larger or smaller than 300 mm.

As seen in FIG. 2, the system 16 generally comprises a controller 18 such as a computer, a chamber 28, a wafer chuck 20 connected to a drive 22, a measurement head 24 and a video monitor 26. The controller 18 preferably comprises pattern recognition software 30. The controller 18 could comprise multiple controllers. The wafer chuck 20 is adapted to support the wafer 12 thereon, such as with vacuum holding for example. The drive 22 can comprise X, Y, Z and θ (Theta) motion controllers 32-35 for moving the wafer chuck 20 in X, Y, Z directions and can axially rotate the chuck. In alternate embodiments additional or alternative component could be used.

The measurement head 24 can comprise a laser and a receiver, and a video camera. Referring also to FIG. 3, in this first embodiment the measurement head 24 is located at a fixed position in the chamber 28. The chamber 28 has a wafer area 36 which is about 450 mm×600 mm in size. The wafer 12 can be positioned directly under the measurement head 24 at a centered position relative to the head 24, but asymmetrically located relative to the area 36 because of the offset location of the head 24. The drive 22 is adapted to move the wafer 12 in the X and Y directions while scanning occurs. The origin of the coordinate system is at the location of the measurement head and the orientation of the axes is shown in FIG. 3. The wafer 12 can be scanned by moving the wafer in the X direction in the range (−150 mm, +150 mm) and in the Y direction in the range (0, +150 mm) to cover quadrants I and II of the wafer (the upper half shown in FIG. 3 of the wafer). The wafer 12 can then be returned to the centered position under the measurement head as shown in FIG. 3 and rotated 180 degrees as illustrated by arrow 42. Because the wafer is rotated 180 degrees, the line orientation on the wafer 12 with respect to the incident laser beam will remain the same. The wafer can be scanned by moving the wafer in the X direction in the range (−150 mm, +150 mm) and in the Y direction in the range (0, +150 mm) to cover quadrants III and IV of the wafer (the lower half shown in FIG. 3 of the wafer). This completes scanning of the entire top surface of the wafer. The measurement head 24 can remain stationary and the wafer only needs to be rotated once 180 degrees.

With the embodiment described above, scanning occurs in two segments with a 180 degree rotation of the wafer between the two scanning segments. The first scanning segment scans the first half of the wafer top surface (quadrants I and II). The second scanning segment scans the second half of the wafer top surface (quadrants III and IV).

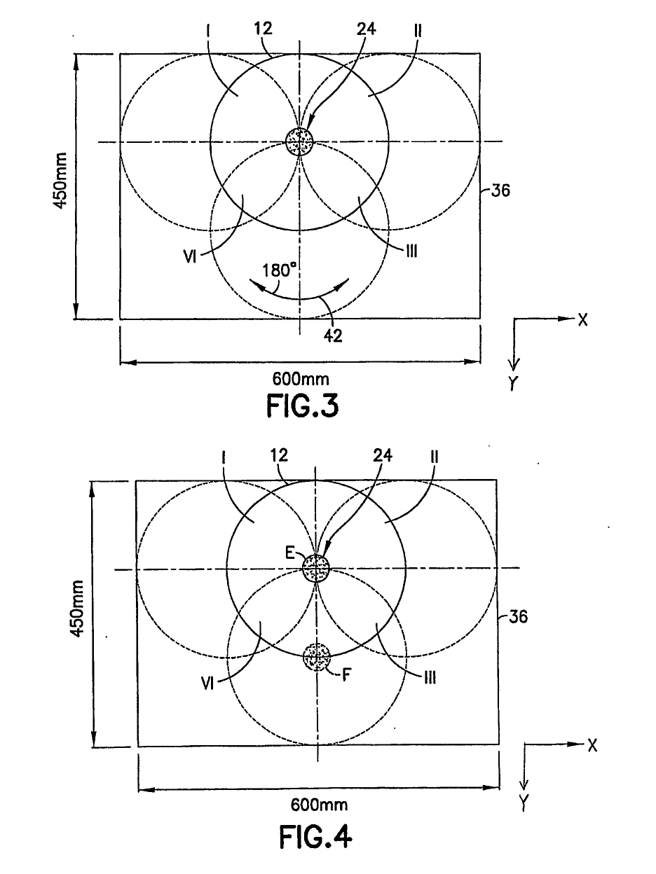

Referring now to FIG. 4, another embodiment is shown. In this embodiment the measurement system 16 comprises a mover 38 (see FIG. 2) for moving the measurement head 24 between two fixed positions E and F. The measurement head 24 remains stationarily fixed at one of the two locations E, F during individual segment scanning of the wafer. Unlike the embodiment shown in FIG. 3, this system and method does not require rotation of the wafer between scanning segments. The method comprises scanning the wafer in the X direction in the range (−150 mm, +150 mm) and in Y direction in the range (0, +150 mm) to cover quadrants I and II of the wafer (the upper half shown in FIG. 4) while the measurement head 24 is at location E. The origin of the coordinate system is at location E and the orientation of the axes is shown in FIG. 4. The measurement head 24 is then moved by translation movement only from location E to location F as shown in FIG. 4. The method then comprises scanning the wafer in the X direction in the range (−150 mm, +150 mm) and in Y direction in the range (+150 mm, 0) to scan quadrants III and IV of the wafer (the lower half shown in FIG. 4).

With this method, scanning occurs in two segments with translation of the measurement head between the two scanning segments. The first scanning segment scans the first half of the wafer top surface (quadrants I and II). The second scanning segment scans the second half of the wafer top surface (quadrants III and IV). The dotted lines in FIG. 4 show the maximum movements of the wafer in the wafer area 36. This wafer area is preferably 450 mm×600 mm for accommodating a 300 mm wafer; a smaller area than the conventional wafer area of 600 mm×600 mm for accommodating a 300 mm wafer.

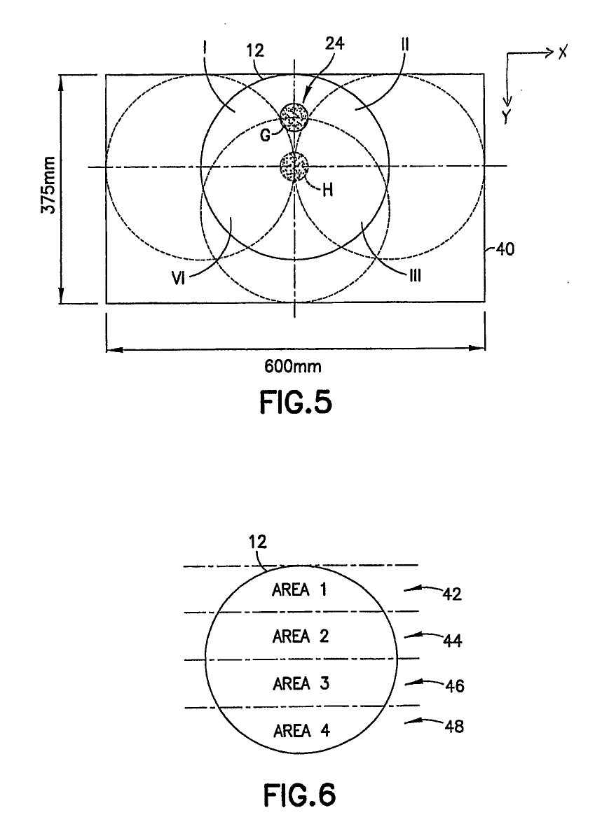

Referring to FIGS. 5 and 6 another embodiment is shown. In this embodiment the measurement system uses both rotation of the wafer by the Theta drive of the drive 22 and translation of the measurement head 24 by the mover 38, but only between scanning segments, not during actual scanning. This embodiment uses four scanning segments rather than two scanning segments. However, in alternate embodiments more or less than four scanning segments could be used.

In this embodiment the chamber 28 has a wafer area 40 which is about 375 mm×600 mm. Scanning starts with the wafer 12 in a position as shown in FIG. 5 beneath the measurement head 24 with the measurement head located off-center from the center of the wafer at position G. The wafer is moved to scan the first scan segment 42 in the X direction in the range (−150 mm, +150 mm) and in the Y direction in the range (0, +75 mm) to cover area 1 of quadrants I and II of the wafer (the upper quarter or Area 1 as shown in FIG. 6). The origin of the coordinate system is at position G and the axes are oriented as shown in FIG. 5. After the first segment (Area 1) is completed, the measurement head 24 is moved by translation only to location H.

The wafer is moved to scan the second scan segment 44 in the X direction in the range (−150 mm, +150 mm) and in Y direction in the range (+75 mm,0) to cover area 2 of quadrants I and II of the wafer. This completes scanning of the upper first half of the wafer top surface. The wafer can then be returned to its home position shown in FIG. 5. The measurement head remains at location H. The wafer 12 is rotated 180 degree by the Theta drive. The line orientation with respect to the incident laser beam will remain the same.

The steps described above are then repeated to scan the lower half of the wafer (Areas 3 and 4). The wafer is moved to scan the third scan segment 46 in the X direction in the range (−150 mm, +150 mm) and in the Y direction in the range (0, +75 mm) to cover area 3 of quadrants III and IV of the wafer (the lower quarter). After the third segment is completed, the measurement head 24 is moved by translation only back to location G. The wafer is moved to scan the fourth scan segment 48 in the X direction in the range (−150 mm, +150 mm) and in Y direction in the range (+75 mm,0) to cover area 4 of quadrants III and IV of the wafer. This completes scanning of the lower second half of the wafer top surface. The dotted lines in FIG. 5 show the maximum outer movements of the wafer 12. In an alternate method the measurement head 24 could be moved from position H back to position G after scanning of the second area 2 to measure area 4 and then move the movement head 24 to position H again for measuring area 3. Thus, area 3 could be scanned during the fourth scan segment and area 4 could be scanned during the third scan segment.

This type of method and system allows reduction in the size of the wafer movement area to an even smaller area than previously needed in a conventional system. In the embodiment described, for a 300 mm wafer the wafer movement area would only need to be 375 mm×600 mm. The use of translation of the movement head between scanning segments and rotation between scanning segments can be modified to provide an even smaller wafer movement area by merely providing move scanning segments and smaller scan areas of the wafer top surface for each scan segment. Of course, there can be some overlap in the adjacent scan areas and scan segments.

The invention can be used to decrease the wafer space needed inside a wafer holding area. The invention can use asymmetric position of the measurement head. The invention can use pattern recognition algorithms to accurately locate measurement points after wafer rotation at 180°. The invention can use two fixed positions of the measurement head to scan the whole wafer surface without a need of rotation. The invention can use a sorting algorithm to arrange orders of the selected measurements points on the wafer so that the effect of wafer rotation on throughput could be minimized.

Variations of the invention can comprise:
Initial positioning which could be done with a Flat Notch (FN) finder.
Initial positioning which could be done with an aligner inside the EFEM module.
The measurement system could be MetaPulse®, ellipsometer, wafer defect inspection tool, etc.
The pattern recognition could use digital image rotation of the trained features after wafer rotation.
The pattern recognition could use digital image rotation on the captured images.

Although the invention has been described with reference to a 300 mm wafer, features of the invention could be used with different size wafers or other items to be scanned.

Use of the apparatus and methods disclosed above generally require that a wafer be placed on the top plate in a known orientation. The invention can also involve substituting an edge inspection mechanism in the spaced saved by utilizing the Wafer Scanning improvement described above, wherein the edge inspection mechanism not only performs an edge inspection, but also provides wafer orientation information useful for implementing the Wafer Scanning methods. Multiple inspection devices can be packaged into a single inspection/metrology tool. Typically, edge inspection tools are entirely separate from inspection tools used to inspect the top surface of a wafer. Further, pre-aligners are almost universally used to align a wafer prior to its transfer onto an inspection tool stage. As described above, it is desirable to minimize the size of the wafer chamber. This permits the size of inspection and metrology tools to be minimized for use in iMod or Track systems. This also permits additional inspection/metrology modules to be added to a size optimized inspection/metrology platform without expanding the size of the infrastructure required to support the module.

In one embodiment of the invention, a wafer is placed on a chuck in a roughly aligned position. An edge top inspection system (such as a camera for example) such as that described in U.S. Pat. No. 6,947,588, which is hereby incorporated by reference in its entirety, may be included in the system to simultaneously perform an edge top (edge bead removal) inspection and determine the position and orientation of the wafer. Another embodiment may include edge normal or edge bottom inspection systems. In yet another embodiment, inspection optics similar to those on an NSX inspection tool (see U.S. Pat. No. 6,826,298 for an example which is hereby incorporated by reference in its entirety) can be used to perform the edge inspection/wafer position and orientation determination.

Omitting a pre-aligner presumes that a wafer can be transferred directly from a FOUP (Front Opening Unified Pod) or cassette within a rather large window of position error. As the field of view of an edge top camera can ‘see’ a large portion of the wafer edge during inspection, at a minimum the wafer should be placed such that at least three positions along the edge of the wafer can be captured. These positions should be sufficiently spaced apart to allow for a circle fit to be made. This would give the position/offset of a wafer with respect to a predefined center of the chuck. Pattern recognition software can be used to determine rotation orientation from images of the patterned wafer top captured by the edge top camera/inspection optics. As a sub-embodiment, a complex path comprising rotation and translation can be derived and implemented to facilitate a full edge top inspection.

Preferably, and much more likely, the structure of most FOUPs and cassettes would not allow for gross positioning errors such as described above. The greatest possible error in positioning the wafer can be determined. Where it is the case that a wafer can be reliably placed to within less than ½ the field of view of the edge top/inspection optics, a full edge top inspection can be accomplished which can include the notch or flat of the wafer. In this way, edge inspection can be accomplished at the same time as position and orientation of the wafer are determined.

In another embodiment, the smaller footprint of the wafer chamber will permit an edge inspection module to be packaged into an existing tool chassis. In this embodiment, a pre-aligner may be omitted as described above or, more likely, be included to facilitate the inspection process.

In an embodiment, the first property may include a critical dimension of the specimen. The second property may include overlay misregistration of the specimen. In addition, the processor may be configured to determine a third and/or a fourth property of the specimen from the one or more output signals. For example, a third property of the specimen may include a presence of defects on the specimen, and the fourth property of the specimen may include a flatness measurement of the specimen. In an embodiment, the measurement device may include a non-imaging scatterometer, a scatterometer, a spectroscopic scatterometer, a reflectometer, a spectroscopic reflectometer, an ellipsometer, a spectroscopic ellipsometer, a bright field imaging device, a dark field imaging device, a bright field and dark field imaging device, a bright field non-imaging device, a dark field non-imaging device, a bright field and dark field non-imaging device, a coherence probe microscope, an interference microscope, an optical profilometer, or any combination thereof. In this manner, the measurement device may be configured to function as a single measurement device or as multiple measurement devices. Because multiple measurement devices may be integrated into a single measurement device of the system, optical elements of a first measurement device, for example, may also be optical elements of a second measurement device.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. A semiconductor wafer measuring device comprising:
a wafer mover adapted to move a semiconductor wafer;
a measurement head adapted to scan a surface of the semiconductor wafer as the semiconductor wafer is moved by the wafer mover; and
a controller adapted to control movement of the wafer mover to provide a first scanning segment of a first portion of the surface of the semiconductor wafer without rotating the semiconductor wafer during the first scanning segment, a second scanning segment of a second different portion of the surface of the semiconductor wafer without rotating the semiconductor wafer during the second scanning segment; and rotating the semiconductor wafer between the first and second scanning segments.

2. A semiconductor wafer measuring device as in claim 1 wherein the measurement head comprises a stationary measurement head.

3. A semiconductor wafer measuring device as in claim 1 wherein the measurement head comprises a measurement head adapted to move by translational movement only between measurement locations.

4. A semiconductor wafer measuring device as in claim 1 wherein the controller is adapted to rotate the semiconductor wafer between only two positions located 180° apart.

5. A semiconductor wafer measuring device as in claim 1 wherein the controller is adapted to move the semiconductor wafer in only translational movements during the first scanning segment.

6. A semiconductor wafer measuring device as in claim 5 wherein the controller is adapted to move the semiconductor wafer in only translational movements during the second scanning segment.

7. A semiconductor wafer measuring device as in claim 1 wherein the surface is a top surface of the wafer, and wherein the first scanning segment comprises about 50 percent of the surface.

8. A semiconductor wafer measuring device as in claim 1 wherein the controller is adapted to control location of the movable measurement head between at least two stationary positions.

9. A semiconductor wafer measuring device as in claim 8 wherein the surface is a top surface of the wafer, and wherein the first scanning segment comprises about 25 percent of the surface.

10. A semiconductor wafer measuring device comprising:
a wafer mover adapted to move a semiconductor wafer;
a movable measurement head adapted to scan a surface of the semiconductor wafer as the semiconductor wafer is moved by the wafer mover; and
a controller adapted to control movement of the wafer mover and the location of the movable measurement head to provide a first scanning segment of a first portion of the surface of the semiconductor wafer without rotating the semiconductor wafer during the first scanning segment and without moving the movable measurement head during the first scanning segment, a second scanning segment of a second different portion of the surface of the semiconductor wafer without rotating the semiconductor wafer during the second scanning segment and without moving the movable measurement head during the second scanning segment; and, after the first scanning segment and before the second scanning segment, moving the movable measurement head by translation movement only from a first position to a second position.

11. A semiconductor wafer measuring device as in claim 10 wherein the first and second positions of the measurement head are stationary positions during the first and second scanning segments.

12. A semiconductor wafer measuring device as in claim 10 wherein the measurement head is movable only between the first and second positions.

13. A semiconductor wafer measuring device as in claim 10 wherein the controller is adapted to rotate the semiconductor wafer between only two rotated positions located 180° apart.

14. A semiconductor wafer measuring device as in claim 10 wherein the controller is adapted to move the semiconductor wafer in only translational movements during the first scanning segment.

15. A semiconductor wafer measuring device as in claim 14 wherein the controller is adapted to move the semiconductor wafer in only translational movements during the second scanning segment.

16. A semiconductor wafer measuring device as in claim 10 wherein the surface is a top surface of the wafer, and wherein the first scanning segment comprises about 50 percent of the surface.

17. A semiconductor wafer measuring device as in claim 10 wherein the surface is a top surface of the wafer, and wherein the first scanning segment comprises about 25 percent of the surface.

18. A semiconductor wafer measurement method comprising:
moving a semiconductor wafer and scanning a first scanning segment of a first portion of a surface of the semiconductor wafer without rotating the semiconductor wafer during the first scanning segment;
moving the semiconductor wafer and scanning a second scanning segment of a second different portion of the surface of the semiconductor wafer without rotating the semiconductor wafer during the second scanning segment; and
rotating the semiconductor wafer between the first and second scanning segments.

19. A method as in claim 18 further comprising aligning the semiconductor wafer prior to scanning the first scanning segment thereof.

20. A method as in claim 18 further comprising transferring the semiconductor wafer directly from a wafer storage mechanism to a wafer mover.

21. A method as in claim 20 further comprising scanning at least a portion of at least one of the first and second scanning segments of the semiconductor wafer to determine the orientation of the semiconductor wafer with respect to the wafer mover.

22. A semiconductor wafer measurement method comprising:
moving a semiconductor wafer and scanning a first scanning segment of a first portion of a surface of the semiconductor wafer without rotating the semiconductor wafer during the first scanning segment and without moving a movable measurement head during the first scanning segment;
moving the semiconductor wafer and scanning a second scanning segment of a second different portion of the surface of the semiconductor wafer without rotating the semiconductor wafer during the second scanning segment and without moving the movable measurement head during the second scanning segment; and
between the first and second scanning segments, moving the movable measurement head by translation movement only from a first position to a second position.

23. A method as in claim 22 further comprising:
after the second scanning segment, rotating the semiconductor wafer;
moving the semiconductor wafer and scanning a third scanning segment of a third portion of a surface of the semiconductor wafer without rotating the semiconductor wafer during the third scanning segment and without moving the movable measurement head during the third scanning segment; and
moving the semiconductor wafer and scanning a fourth scanning segment of a forth different portion of the surface of the semiconductor wafer without rotating the semiconductor wafer during the forth scanning segment and without moving the movable measurement head during the forth scanning segment.
